(19) United States
(12) Patent Application Publication
(10) Pub. No.: US 2015/0321406 A1
(43) Pub. Date: Nov. 12, 2015

(54) CONTROL METHOD FOR INJECTION MOLDING MACHINE

(71) Applicant: FANUC CORPORATION, Minamitsuru-gun (JP)

(72) Inventors: Tatsuhiro UCHIYAMA, Yamanashi (JP); Hideki KOYAMA, Yamanashi (JP); Tetsuharu URUSHIZAKI, Yamanashi (JP)

(21) Appl. No.: 14/707,043

(22) Filed: May 8, 2015

(30) Foreign Application Priority Data
May 12, 2014 (JP) 2014-098954

(51) Int. Cl. B29C 45/76

(52) U.S. Cl. CPC B29C 45/7666; B29L 2031/772

(57) ABSTRACT

Disclosed is a control method for an injection molding machine, which is provided with a movable part, an electric storage device configured to store energy, and an energy supply unit configured to supply at least some of necessary energy for operation of the movable part from the electric storage device. In this injection molding machine control method, an amount of energy storable in the electric storage device is changed based on an energy index value as an index of the necessary energy for the operation of the movable part.

### BACKGROUND OF THE INVENTION

1. Field of the Invention

The present invention relates to a control method for an injection molding machine.

2. Description of the Related Art

Generally, in an injection device and a mold clamping device of an injection molding machine, a servomotor is used to drive movable parts, such as a screw, movable platen, and the like, which are advanced or retreated as the servomotor is supplied with drive power from its drive unit. High electric power is required when the mold clamping device creates a clamping force, as well as when the injection device moves the screw at high speed during injection.

In driving the servomotor at a high output level, high power must be supplied from an amplifier to the servomotor. However, a large power supply capacity is needed in order to cover all the high power with electric power from a main power supply. Thus, the costs of the molding machine body and user power supply equipment may be considerably increased. To solve this problem, there is a known technique in which some or all of necessary energy to be supplied to the servomotor for injection and mold clamping is previously stored in a power storage device, and the stored energy is released and supplied to the servomotor when injection and mold clamping operations are started, so that a power supply unit can be reduced in size, based on independent performance of the operations (Japanese Patent Application Laid-Open No. 2000-141440).

In general, an injection molding machine can be equipped with injection cylinders of a plurality of types with different injection capacities, and therefore, can handle molded articles of different sizes, without changing its injection mechanism. A user who uses the injection molding machine selects an injection cylinder with a large injection capacity in molding a large molded article, and on the other hand, uses an injection cylinder with a small injection capacity in molding a small molded article.

Generally, in molding a large molded article, the injection capacity is large, so that the necessary energy for injection is high. In molding a small molded article, in contrast, the injection capacity is small, so that the necessary energy for injection is low. In order to compatibly use both the cylinders with large and small injection capacities in the injection molding machine with a single injection mechanism, however, it is necessary to previously mount a large-capacity electric storage device that can be stored with high energy to match the large-capacity cylinder.

For the user who molds only small molded articles using the injection molding machine with the single injection mechanism, however, the electric storage device that can store high energy is too large to be mounted in the machine and may possibly require extra costs, though it can supply a sufficient amount of energy. Since the too large electric storage device is bulky and heavy, moreover, it may be low in maintainability.

Japanese Patent Application Laid-Open No. 2000-141440 also discloses how energy is previously stored in an electric storage device of the injection molding machine and is released when the injection and mold clamping operations are performed. Since the electric storage device is not assumed to be changed depending on the necessary amount of energy for the injection molding machine, however, it may require extra costs or its maintainability may get worse.

### SUMMARY OF THE INVENTION

Accordingly, the object of the present invention is to provide a control method for an injection molding machine, capable of reducing extra costs of the injection molding machine and facilitating maintenance work.

A control method for an injection molding machine according to the present invention is a method for controlling the injection molding machine comprising a movable part, an electric storage device configured to store energy, and an energy supply unit configured to supply at least some of necessary energy for operation of the movable part from the electric storage device. The control method comprises a step of changing an amount of energy storable in the electric storage device based on an energy index value as an index of the necessary energy for the operation of the movable part.

The injection molding machine can be equipped with the electric storage device best suited for an injection capacity, clamping force, and ejector driving force by changing the amount of energy storable in the electric storage device based on the energy index value as the index of the necessary energy for the operation of the movable part. Accordingly, extra costs of the injection molding machine can be reduced and the electric storage device can be used in accordance with the necessary amount of energy. Thus, the electric storage device can be reduced in size and weight as a whole, so that its maintenance work can be facilitated.

The movable part may be an injection unit and the energy index value may be an injection capacity equivalent to the product of an injection stroke and the cross-sectional area of a screw of the injection unit. Alternatively, the movable part may be a mold clamping unit and the energy index value may be a clamping force of the mold clamping unit. Alternatively, moreover, the movable part may be an ejector and the energy index value may be a forward driving force of the ejector.

The electric storage device may comprise one or more combinations of electric storage modules of a plurality of types with different storable amounts of energy. Alternatively, the electric storage device may comprise one or more combinations of electric storage modules with substantially equal storable amounts of energy.

The electric storage device best suited for the injection capacity, clamping force, and ejector driving force can be easily constructed by combining the electric storage modules of the plurality of types with different storable amounts of energy or the electric storage modules with substantially equal storable amounts of energy. Thus, the electric storage device can be reduced in size and weight as a whole, so that its maintenance work can be facilitated.

The number of combined electric storage modules may be calculated from the necessary energy for the operation of the movable part and an amount of energy capable of being supplied from each of the electric storage modules.

The number of combined electric storage modules can be minimized by being calculated from the necessary energy for the operation of the movable part and the amount of energy capable of being supplied from each of the electric storage modules, so that costs can be reduced. Thus, the electric storage device can be reduced in size and weight as a whole, so that its maintenance work can be facilitated.

According to the present invention configured as described above, there can be provided a control method for an injection molding machine, capable of reducing extra costs of the injection molding machine and facilitating maintenance work.

### BRIEF DESCRIPTION OF THE DRAWINGS

The above and other objects and features of the present invention will be obvious from the ensuing description of embodiments with reference to the accompanying drawings, in which:

FIG. 1 is a diagram showing a servomotor driver of an injection molding machine according to one embodiment of the present invention;

FIGS. 2A, 2B and 2C show examples of electric storage devices in which electric storage modules with different storable amounts of energy are connected; and

FIGS. 3A, 3B and 3C show examples of electric storage devices in which electric storage modules with substantially equal storable amounts of energy are connected.

### DETAILED DESCRIPTION OF THE PREFERRED EMBODIMENTS

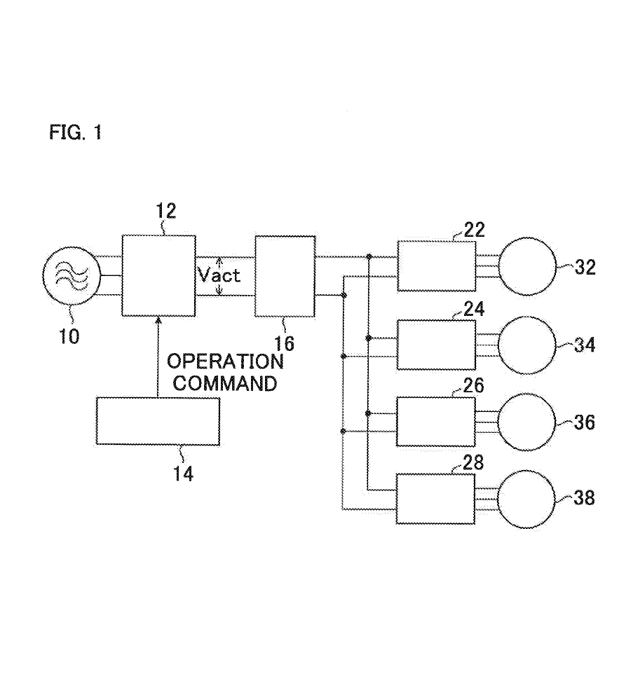

FIG. 1 is a diagram showing a servomotor driver of an injection molding machine according to one embodiment of the present invention. A power converter 12 is connected to a power source 10. The power converter 12 is a device for converting three-phase AC voltage supplied from the power source 10 to DC voltage. Further, numeral 14 denotes a power converter control unit, which issues an operation command to the power converter 12. A power storage unit 16 is connected to the power converter 12. In FIG. 1, symbol Vact designates the voltage of the power storage unit.

The voltage between the two lines that connect the power converter 12 and the power storage unit 16 is defined as the voltage of the power storage unit 16. In the present embodiment, the power storage unit 16 comprises one or more electric storage devices, which are connected to drive units 22, 24, 26 and 28 for driving various motors. The drive units are inverters that PWM-converts DC power and output three-phase AC motor drive power. The drive units are individually connected to various motors, including an injection motor 32, rotary motor 34, mold opening/closing motor 36, and ejector motor 38. The power storage unit 16 is stored with power supplied from the power converter 12. However, the power storage unit 16 can also be configured to store regenerative power generated by the motors, if any.

In a controller for the injection molding machine constructed in this manner, the power converter 12 is turned on or off in response to the operation command from the power converter control unit 14. The power from the power source 10 is supplied to the power storage unit 16 when the power converter 12 is on. The power from the power storage unit 16 is supplied to the drive unit for the driven one of the motors. The power storage unit 16 increases its voltage on receiving the power supplied from the power source 10 as the power converter 12 is turned on. The voltage of the power storage unit 16 is reduced as the power is supplied to the various drive units.

The molding cycle of the injection molding machine comprises a process of closing a mold, process of injecting a molten resin into the mold, process of measuring the resin while melting it for the next molding cycle, process of opening the mold, and process of ejecting a molded article from the mold. The “molding cycle” described herein represents a cycle comprising this series of processes.

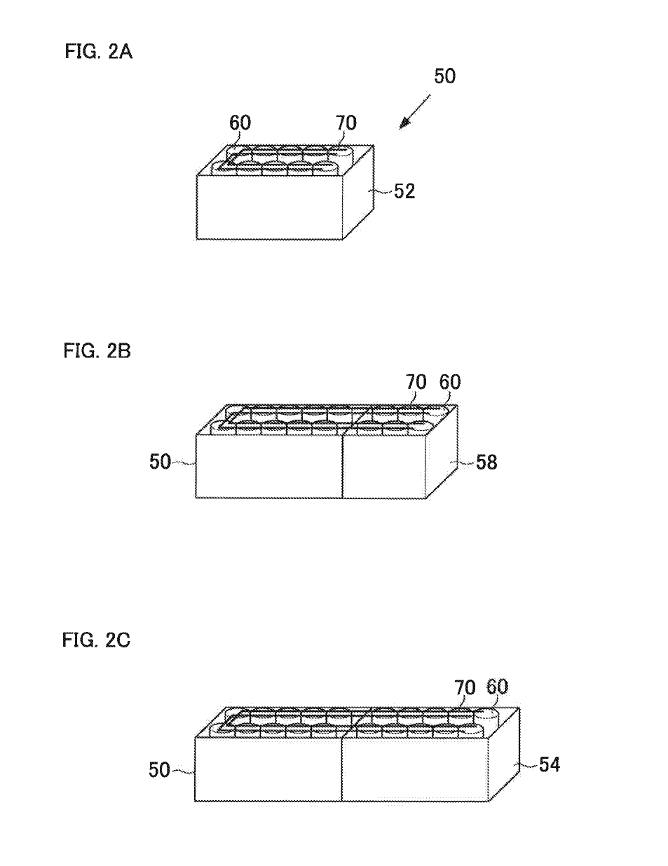

FIGS. 2A, 2B and 2C show examples in which an electric storage module based on capacitors is applied to the power storage unit 16. The electric storage module based on the capacitors is configured so that its storable amount of energy can be adjusted to a predetermined value by settling the capacitance of the capacitors. FIG. 2A shows a common module 50 that can store the necessary amount of energy for a minimum injection capacity. As shown in FIG. 2A, the common module 50 is constructed so that one or more capacitors 60 are arranged in a case body 52 and connected to one another by a bus bar 70, thereby having a predetermined capacitance as a whole. The electric storage module, along with the common module 50 and additional modules 54 and 58 (described later), is configured to be individually attachable to and detachable from the injection molding machine.

FIG. 2B shows an example in which the injection capacity is larger than the minimum injection capacity. Since the amount of energy of the common module 50 alone is insufficient, the additional module 58 is added and connected to the common module 50. Capacitors in the additional module 58 are also connected to those in the common module 50 by the bus bar 70, whereby the value of the total capacitance can be increased.

FIG. 2C shows another example in which the injection capacity is larger than the minimum injection capacity. The additional module 54, which is larger in capacity than the additional module 58 of FIG. 2B, is added and connected to the common module 50. As in the case of FIG. 2B, capacitors in the additional module 54 are also connected to those in the common module 50 by the bus bar 70, whereby the value of the capacitance can be increased more than in the case of FIG. 2B.

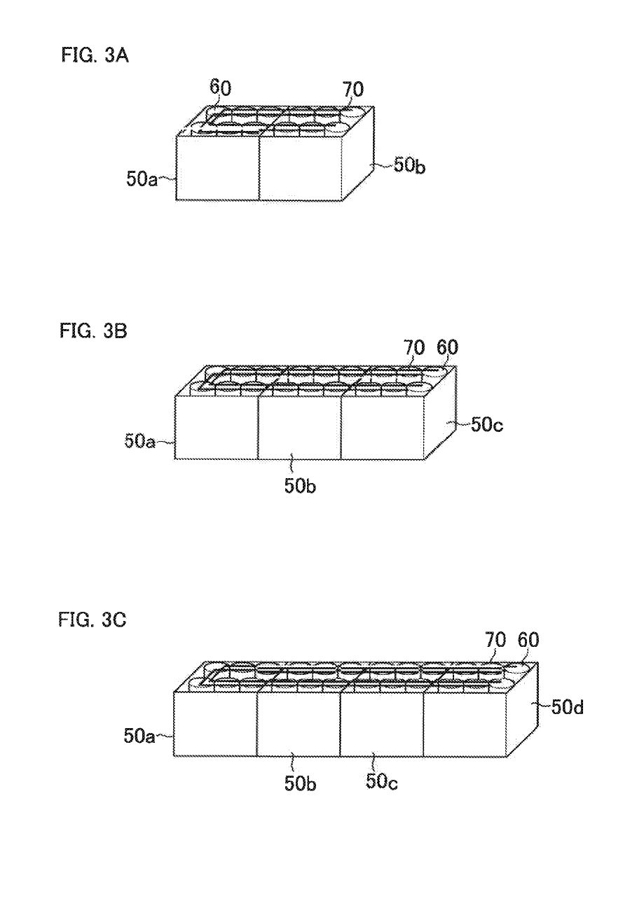

In the examples shown in FIGS. 2A to 2C, the electric storage modules with different storable amounts of energy are connected to one another. In examples shown in FIGS. 3A, 3B and 3C, in contrast, common modules 50 with substantially equal storable amounts of energy are prepared in advance so that the number of common modules 50 to be connected can be changed depending on the necessary capacitance. As shown in FIG. 3A, two common modules 50a and 50b are connected for the minimum injection capacity. For the case where the injection capacity is larger than the minimum injection capacity, three common modules 50a, 50b and 50c may be connected in the manner shown in FIG. 3B, four common modules 50a, 50b, 50c and 50d may be connected in the manner shown in FIG. 3C, or more common modules 50 may be connected to one another. In any of these cases, the capacitors 60 in each common module 50 can be connected to one another by the bus bar 70 so that the value of the total capacitance is increased.

The following is a description of a method of calculating the number of connected common modules 50 with substantially equal storable amounts of energy in each of the examples shown in FIGS. 3A to 3C.

Necessary energy Ei to be supplied to an injection servomotor in the injection process can be calculated according to expression (1). If the cross-sectional area (S in expression (1)) of a screw in a cylinder and the injection stroke (∫Vdt in expression (1)) increase, the injection capacity ((cross-sectional area of screw)×(injection stroke); ∫(S×V)dt in expression (1)) increases. Thus, expression (1) reveals that the larger the injection capacity, the larger the necessary energy for injection becomes, in the case where the injection is performed at substantially the same resin pressure. In order to cover some or all of the necessary energy for the injection process by an electric storage device, therefore, electric storage modules should only be prepared depending on the injection capacity. Thus, the injection capacity is an index of the necessary energy for injection operation of an injection unit.

Expression (1) is given as follows:

Ei=A+B, (1)

where A is the kinetic energy of the motor and an injection mechanism section (=0.5×I×ω²); I, inertia of the motor and the mechanism section; co, angular velocity of the motor; B, workload on the resin (=∫(P×S×V)dt); P, resin pressure; S, cross-sectional area of the screw; and V, forward speed of the screw.

If the capacitance of each electric storage module is F and if power storage voltages of the electric storage module at the start and end of energy supply therefrom are Vs and Ve (Vs>Ve), respectively, energy Ec supplied from each electric storage module is

Ec=F×(Vs²−Ve²)/2, (2)

so that the number (N) of electric storage modules necessary to supply the necessary energy Ei for the injection operation of the injection unit should only be a minimum integer that satisfies expression (3) as follows:

Ei/Ec≦N. (3)

If the necessary energy Ei for the injection operation of the injection unit is supplied from both the electric storage modules and the power supply, moreover, the number N of electric storage modules should only be set to a minimum integer that satisfies expression (4) as follows:

(G×Ei)/Ec≦N, (4)

where G (0<G≦1) is the ratio of energy supply from the electric storage modules.

If the electric storage modules with different capacitances are used as shown in FIGS. 2A to 2C, moreover, the number of electric storage modules can be calculated in the following manner. In the case where electric storage modules each having a capacitance F1 and electric storage modules each having a capacitance F2 are used, for example, energy Ec1 supplied by the former and energy Ec2 supplied by the latter are given by

Ec1=F1×(Vs²−Ve²)/2, (5)

Ec2=F2×(Vs²−Ve²)/2, (6)

respectively. Therefore, it is necessary only that L and M that satisfy expression (7) as follows:

Ei≦L×Ec1+M×Ec2 (7)

be calculated, where L is the number of used electric storage modules each having the capacitance F1 and M is the number of used electric storage modules each having the capacitance F2.

As indicated by expression (8), moreover, necessary energy (Ef) to be supplied to the servomotor for mold clamping in a mold clamping process changes depending on a clamping force (F). In order to cover some or all of the necessary energy for the mold clamping process by an electric storage device, therefore, electric storage modules that can store energy in an amount corresponding to the clamping force (F) should only be prepared. Thus, the clamping force (F) is an index of the necessary energy for mold clamping operation of a mold clamping unit.

Expression (8) is given as follows:

Ef=C+D, (8)

where C is the kinetic energy of the motor and a mold clamping mechanism section (=0.5×I×ω²); I, inertia of the motor and the mechanism section; co, angular velocity of the motor; D, necessary energy for the creation of the clamping force (=K·X²/2=F²/(2K)); F, clamping force; K, elastic modulus of the mold clamping mechanism section; and X, elongation of a tie-bar during the creation of the clamping force F.

The number of electric storage modules, like that described in connection with the necessary energy for the mold clamping operation, can be calculated from the necessary energy for the mold clamping process and the energy of the electric storage modules.

In the case where some or all of the necessary energy for some other process than the injection process and the mold clamping process is covered by an electric storage device, moreover, electric storage modules should only be prepared depending on the moving distance of the movable part, force created by the movable part, and the like.

In the case where the servomotor for ejector is advanced to eject a molded article from the mold or pressurize the resin, the necessary energy should only be calculated based on the forward driving force of the ejector in the same method as that given by expression (8). In this case, K should only be used as the compressibility factor of the resin, based on an ejection force or pressurizing force as the forward driving force of the ejector in place of the clamping force F in expression (8). Thus, the forward driving force of the ejector is an index of the necessary energy for advancing operation of the ejector.

1. A control method for an injection molding machine, which comprises a movable part, an electric storage device configured to store energy, and an energy supply unit configured to supply at least some of necessary energy for operation of the movable part from the electric storage device, the injection molding machine control method comprising:
a step of changing an amount of energy storable in the electric storage device based on an energy index value as an index of the necessary energy for the operation of the movable part.

2. The control method for an injection molding machine according to claim 1, wherein the movable part is an injection unit and the energy index value is an injection capacity equivalent to the product of an injection stroke and the cross-sectional area of a screw of the injection unit.

3. The control method for an injection molding machine according to claim 1, wherein the movable part is a mold clamping unit and the energy index value is a clamping force of the mold clamping unit.

4. The control method for an injection molding machine according to claim 1, wherein the movable part is an ejector and the energy index value is a forward driving force of the ejector.

5. The control method for an injection molding machine according to claim 1, wherein the electric storage device comprises one or more combinations of electric storage modules of a plurality of types with different storable amounts of energy.

6. The control method for an injection molding machine according to claim 1, wherein the electric storage device comprises one or more combinations of electric storage modules with substantially equal storable amounts of energy.

7. The control method for an injection molding machine according to claim 5, wherein the number of combined electric storage modules is calculated from the necessary energy for the operation of the movable part and an amount of energy capable of being supplied from each of the electric storage modules.
